(19) United States
(12) Patent Application Publication
(10) Pub. No.: US 2003/0034340 A1
(43) Pub. Date: Feb. 20, 2003

(54) Portable tire heating container

(76) Inventor: Frank E. Petersen, Stevensville, MD (US)

Correspondence Address: Frank E. Petersen, 241 Lighthouse View Drive, Stevensville, MD, 21666, US

(21) Appl. No.: 09/985,232

(22) Filed: Nov. 2, 2001

Related U.S. Application Data
(60) Provisional application No. 60/245,210, filed on Nov. 3, 2000.

(51) Int. Cl. F27D 11/00

(52) U.S. Cl. 219/386; 219/521; 219/400

(57) ABSTRACT

A method and apparatus for generating heat and applying same to tire(s). The body of the container is composed of a heat-resistent material of sufficient size to accommodate heating of one or more rubber tires. In addition, container includes a tire air pressure gauge (1).

### CROSS-REFERENCE TO RELATED APPLICATIONS

This application claims a priority to related provisional patent application No. 60/245,210 filed Nov. 3, 2000 by inventor Frank E. Petersen and titled: PORTABLE TIRE HEATING CONTAINER.

### BACKGROUND

1. Field of Invention

This invention relates to apparatus and related methods or processes for the generation of heat and its application to materials, and for subcombinations and adjuncts to such heating, specifically to such apparatus which are used for the application of heat to tires.

2. Description of Prior Art

Research of prior art reveals no description of any invention or specific technology which addresses the problem which this invention applies.

A review of several classifications, including, heat exchanging systems, class 165, material heating devises in class 432, heating systems in class 237 and electrical heating devises in class 219 revealed no similar device for the application of heat to tires.

The only prior art noted related to tires involved speed control devices in class 152.

### SUMMARY

In accordance with the present invention, the portable tire heating container is a method and apparatus for preheating tires, primarily for racing vehicles.

### OBJECTS AND ADVANTAGES

Several objects and advantages of the present invention are:

(a) to provide a means for preheating tires used on racing car automobiles and vehicles;

(b) to provide a portable unit by which tires may be heated prior to attachment to a vehicle not dependent on any stationary location;

(c) to provide a method to increase the speed capacity of stock car racing vehicles;

(d) to provide a method to improve and increase the life span of tires used on racing vehicles;

(e) to provide an apparatus which can be used to determine and adjust tire pneumatic pressure.

### DRAWING FIGURE(S)

FIG. 1 shows a generic “single” unit tire heating container with an air pressure gauge.

### REFERENCE NUMERALS IN DRAWING

1 air pump and pressure gauge

2 portable generator

3 heating element

4 thermostat

5 heating compartment base

6 tire heating chamber side

7 air circulating fan

### DESCRIPTION—PREFERRED EMBODIMENT

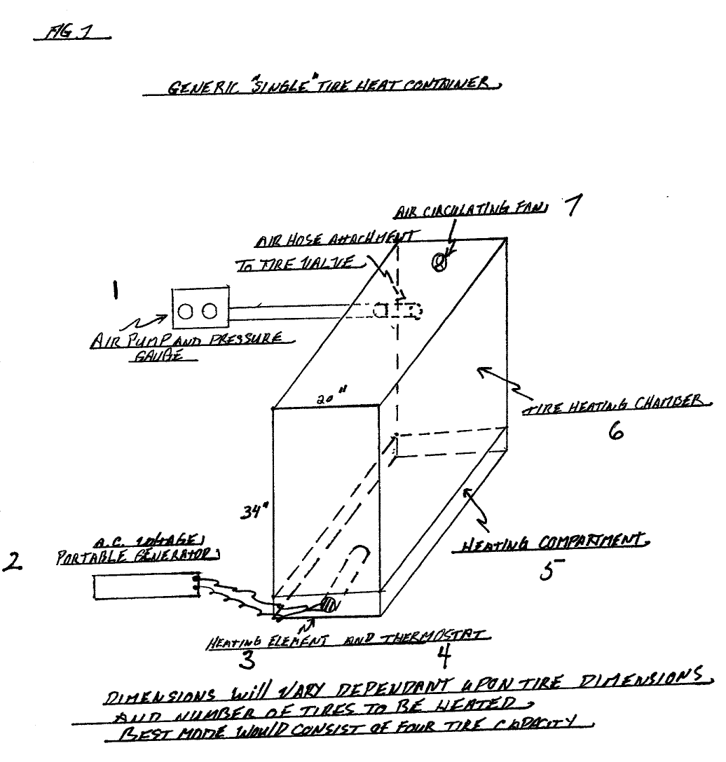

A preferred embodiment of the portable tire heating container is one which will accommodate a four tire capacity and an air pressure gauge. FIG. 1 illustrates a generic “single” tire heating container with the air pressure gauge. The heating container, single and multiple unit embodiments, provides a method and apparatus for pre-heating tires, primarily, tires for racing vehicles for the purpose of achieving optimum racing or driving performance.

The process is carried out by placing one or more tires into the tire heating chamber or container, and heating the tire(s) to a pre-determined temperature just prior to mounting on the vehicle. The container is also designed to simultaneously allow for the determination and adjustment of the tire pneumatic pressure. The invention functions to reduce initial tire flexing and stabilize tire pressure. This function will ultimately extend the life and use of the tire during a racing cycle.

A heating container provides pre-selected temperature to heat tire casing to desired temperature. This would be determined by ambient temperature and race track or other road surface conditions. Simultaneously, an air pressure gauge and air pressure pump is attached to the tire valve stem so that tire internal air pressure can be monitored and adjusted to meet pre-selected parameters as chosen by the operator or maintenance personnal.

The dimensions of any one tire heating container will vary dependent upon tire size and capacity. The container is designed with a heating element capable of providing chamber internal temperature up to 150 degrees. An air hose is attached to the tire valve stem with a pressure monitoring gauge. This will allow for the increase or decrease of air pressure within the tire.

FIG. 1 shows a typical generic single tire container. The container consists of a tire pressure gauge, an air pressure pump, a thermostat connected to a 220v A/C heating element and an insulated metal heated chamber with an air circulating fan. The chamber as depicted is a single tire configuration measuring 34 inches by 24 inches by 34 inches. Access panels in the sides of the container allow attachment of an air hose to the tire value stem which with an air pump and pressure gauge attached allows the operator to monitor and vary internal tire pressure as tire is being heated The thermostat allows the operator to vary internal temperature as desired. An external power source is required, preferably 220v A/C.

The process of the invention is in heating one or more tires to average temperature of at least 90 degrees Fahrenheit within ten (10) minutes. The active heating phase consists of applying heat to the exterior surface of the tire within a heating chamber containing a heating element and an air circulating fan. The heating element is provided with plugs for receiving a power cord inserted into a portable 110-120-220 A/C volt generator power supply source. A 220 voltage is preferred as the heating time would be decreased by half. Use of a battery-operated source would be less practicable. The power source and heating element used in the heating container or chamber is capable of applying from 90 degrees Fahrenheit to 120 degrees Fahrenheit of heat to one or more tires.

The specific heating time of any one tire will depend upon the voltage input and desired temperature as dictated by race track or surface environmental conditions. The most optimal tire temperature will depend on surface environmental conditions and ambient temperature.

Each tire container unit maintains the pre-selected temperature by manually controlled thermostat. The container itself is comprised of a heat resistant material, or alternatively, metal. A heat resistant material is preferred because of weight considerations and mobility needs. Metal, for this reason would be less preferred material.

Another preferred feature of the invention is the provision of a tire air pressure gauge, comprised of a heat resistant quick release air hose attachment to the tire valve with T-fitting attachment to air pump allowing internal tire air pressure to be adjusted as desired.

### OPERATION

The manner of using the tire heating container to heat a tire is not presently known to be in use. First, one places the tire(s) into the heating container unit. Then, attach the air hose to the tire valve stem. Manually select the desired temperature for the container, inflate tire pressure to desire setting using the air pump. Monitor thermostat and air pressure gauge to ensure desired settings are being achieved. Reset desired settings as track or surface conditions vary as use requires.

### CONCLUSION

Accordingly, the reader will see that the portable tire heating container will allow for the heating of a tire easily and conveniently. It will provide a means for the heating of a tire, particularly, for racing vehicles, which will improve the speed capacity of the vehicle and extend the life of the tire(s) itself. This will result in a significant savings in the number of tires needed for such activity and decrease the level of accidents and delay due to rapidly over-worn tires, which is problematic in the racing industry.

Although the description above contains many specifications, these should not be construed as limiting the scope of the invention but as merely providing illustration of the presently preferred embodiment of this invention. For example, the tire heating container can have other shapes, dimensions, etc., may have a different source of power supply, with rotatable wheels and/or can be made to operate with or without an air pressure gauge.

1. A method and apparatus for generating heat for its application to tire(s) and a means therein for regulating tire temperature, comprising:
(A) a body chamber or unit composed of material of sufficient size to accommodate one or more tires
(B) with a heating element and thermostat and
(C) a means for controlling tire temperature whereby said tire will be heated at predetermined parameter.

2. A method and apparatus for generating heat for its application to tire(s) and further including a means therein for regulating tire temperature and air pressure, comprising:
(A) a body chamber or unit of material having sufficient size to accommodate one or more tires
(B) with a heating element and thermostat and
(C) a means for controlling tire temperature and air pressure whereby said tire will be heated and pressurized at predetermined parameter.
